(19) United States
(12) Patent Application Publication
(10) Pub. No.: US 2006/0258226 A1
(43) Pub. Date: Nov. 16, 2006

(54) Interchangeable Cover Power Strip

(76) Inventor: Henry Milan, Rochester, MI (US)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/382,816

(22) Filed: May 11, 2006

Related U.S. Application Data
(60) Provisional application No. 60/680,207, filed on May 12, 2005.
(60) Provisional application No. 60/712,547, filed on Aug. 30, 2005.

(51) Int. Cl. H01R 25/00

(52) U.S. Cl. 439/652

(57) ABSTRACT

A power strip includes a base unit providing the electrical functions and an interchangeable cover having ornamental features. The cover can have releasably or fixedly attached portions that permit mixing and matching of colors and styling. The base unit can be modular to provide additional options.

### CROSS-REFERENCE TO RELATED APPLICATION

This application claims the benefit of U.S. provisional patent application Ser. No. 60/680,207 filed May 12, 2005 and U.S. provisional patent application Ser. No. 60/712,547 filed Aug. 30, 2005.

### BACKGROUND OF THE INVENTION

The present invention deals with outlet or power strips, and more particularly, with removable and interchangeable covers for power strips. The present invention also concerns an outlet strip which may be in the form of a surge protector of the type commonly used to protect sensitive electrically operated equipment from line current surges. Most particularly, the invention deals with a modular outlet strip or surge protector having several types of sections which are quickly connected and disconnected by virtue of “quick connect” means provided on the modules. Electrically operated equipment, practically since its inception, has been subject to surges of current over the three power lines to which it is connected. These current surges can be caused by naturally occurring phenomenon, such as lightning strikes during thunderstorms, which induce power surges in the power lines, or by man-made causes, such as sudden variations in the power being output from a generating station due to failures of components or other generators going on- or off-line.

Some types of electrical equipment have been developed which are more sensitive to line current surges than other types. Equipment which is particularly sensitive is in the nature of television sets, stereos, answering machines, and more recently, computer equipment. Ever since the advent of this sensitive electronic equipment, those in the art have sought a convenient and economical way to protect such electrical equipment from power surges. Many surge protectors are known in the prior art, and all operate by generally well-known principles, such as by capacitors connected between live and earth which discharge in the presence of a sudden surge of power and effectively short out that surge of power before it can reach the power supply cords plugged in to such surge protectors.

However, the outlet strips and surge protectors available in the prior art are generally of one type. They consist of a line cord with the surge protection, where used, connected across many outlets connected in parallel. Normally, the surge protectors have an on/off switch, an indicator light, and from six to ten receptacles. In many cases, only one or two receptacles are needed at a particular location, and the excess of receptacles provides for a bulky and inconvenient appliance.

Also, with the advent of computers with built-in telephone modems, a modem surge protector is many times needed in conjunction with a line current surge protector so that both the phone modern and the computer are protected from surges of current which may occur simultaneously. Thus, those skilled in the art have continued to search for solutions to the problems of how to provide a convenient, compact, and yet adaptable, surge protector.

The following patents provide background in the field of housings for outlet strips and other electrical devices:

U.S. Pat. No. 4,735,577 entitled “Extruded Outlet Strip”.

U.S. Pat. No. 4,979,907 entitled “Outlet Strip Assembly with Integral Multiple Receptacles”.

U.S. Pat. No. 5,551,497 entitled “Decorative Computer Keyboard Cover”.

U.S. Pat. No. 5,780,775 entitled “Power Strip with Inspection Window”.

U.S. Pat. No. 6,015,307 entitled “Electric Outlet with Rotary Socket Bodies”.

U.S. Pat. No. 6,406,308 entitled “Safety Device and Dust Protection for a Power Strip”.

U.S. Pat. No. 6,709,078 entitled “Decorative, Adjustable, Protective Cover Frame for Electronic Equipment and Furniture”.

As stated in U.S. Pat. No. 4,735,577, multiple electrical outlet strips are very useful devices for facilitating the operation of multiple electrically powered components at a single location. Conventional multiple electrical outlet strips, such as shown in U.S. Pats. Nos. 2,743,423 and 4,113,334, usually comprise a metal casing having a plurality of outlet receptacles received by openings in one face of the casing, and connected together internally by a number of wires. Normally the outlet receptacles are integral components with their own terminals for receipt of male electrical plug prongs, with the outlet receptacles electrically interconnected by conventional wiring. Proposals have been made (see co-pending application Ser. No. 190,050 filed Sep. 23, 1980) for allowing the common wiring to provide the electrical contacts for the outlet receptacles, with the receptacles mounted within the casing in basically the same manner. Conventional housings for multiple electrical outlet strips are usually provided by pre-sized cans, or metal extrusions.

While conventional multiple electrical outlet strips perform their intended functions well, the costs of construction thereof are higher than desirable. The utilization of outlet receptacles requires that the receptacles be wired to each other and to the power source, and high labor costs are often associated therewith for the wiring of the receptacles together and the insertion of the receptacles into the casing. Additionally, the provision of the multiple receptacles provides relatively high component costs, and minimizes the flexibility of forming multiple electrical outlet strips of varying numbers of plug positions.

According to the invention shown in U.S. Pat. No. 4,735,577, a multiple electrical outlet strip, and method of production thereof, are provided that result in the extremely inexpensive construction thereof. An outlet strip according to the invention is produced with a minimum of tooling costs as well as a minimum of labor costs, yet the outlet strip according to the invention has even better mechanical and electrical properties than conventional multiple electrical outlet strips. Once the length of the strip has been established, the cost will be the same irrespective of how many outlets it has since individual outlet receptacles are not utilized.

Further a multiple electrical outlet strip is produced by extruding an elongated housing from electrically insulating material (preferably plastic). The housing extrusion has at least a top surface and side walls, and includes elongated electrically conductive material-receiving interior channels. The elongated housing extrusion is severed to provide a housing of a predetermined length having opposite open ends, and a plurality of spaced through-extending openings are formed in the housing top surface adjacent the electrically conductive material-receiving interior channels. The openings comprise at least two spaced sets of spaced openings for receipt of male electrical plug prongs. Electrically conductive material, such as brass strips with locking portions, is inserted into operative association with each of the electrically conductive material-receiving interior channels, the locking portions maintaining the strips in place within the housing.

The brass strips are electrically interconnected to an electricity conducting element, such as a conventional electrical cord, which extends exteriorly of the housing. Wire sections from the stripped end of an electrical cord may be brought into contact with the brass strips to effect this interconnection. End covers are then connected to the open ends of the housing, providing a complete multiple electrical outlet strip.

Preferably the extruding of the housing is accomplished by extruding a channel-shaped housing having an open bottom, and a bottom member adapted to cooperate with the open bottom of the housing is also extruded. Preferably interlocking portions on the housing and bottom are extruded and the bottom, once cut to the appropriate length, is slid into operative association with the housing, and can be held in place by the end covers. A plurality of self-tapping screw-receiving channels are preferably extruded in the interior of the housing and the end covers are connected to the open ends of the housing by passing self-tapping screws through each of the end caps into operative association with the screw-receiving channels which have been extruded.

In order to provide guidance of male plugs into the openings formed-in the housing top surface therefor, upwardly-opening guide channels are extruded in the exterior of the top surface of the housing, and the openings are formed within the guide channels. Cover-receiving surface manifestations also are desirably extruded in the housing, and a cover of electrical insulating material having surface manifestations cooperating with the housing surface manifestations is preferably extruded and moved into operative association with the housing to cover any desired number of male electrical plug prong-receiving openings in the top of the housing.

The same extrusion profile is used for both the back cover and the top and outlet sliding covers.

Two types of outlet strips are widely utilized at present. The conventional type of outlet strip assembly generally comprises a cover plate, an adjacent base and receptacles in the form of singular piece or pairs, in addition to necessary electrical elements disposed therein or connected thereto to establish a complete electrical connection. As is required, the cover plate and adjacent base are both made of metals and the receptacles are made of insulated materials such as plastics. Each pair of receptacles is separately and securely mounted on the cover plate by screws or the like, with wires connecting common positive or negative terminals to respective receptacles.

One obvious drawback of such construction is that the work required for separately mounting each pair of receptacles on the cover plate and for connecting adjacent receptacles by wires can be time-consuming.

The more recent type of outlet strip assembly comprises a cover plate having all receptacles integrally formed thereon, an adjacent base associated with the cover plate, and three bus bars (for hot wire, neutral wire and grounding wire, respectively) running through each and every receptacle. The cover plate and the adjacent base are preferably made of plastic material, for example, by injection molding. As is apparent, in this type of outlet strip assembly, the bus bars replace the wires for connecting common positive or negative terminals of respective receptacle and the electrical elements received within the receptacles. Further, the receptacles are permanently fixed on the cover plate forming an integral part thereof. While this type of outlet strip assembly is simple in construction it still has drawbacks. For instance, since the receptacles are integrally and fixedly formed on the cover plate, it is difficult, if not impossible, to have the cover plate and the receptacles made of separate colors. In addition, it is not possible that the cover plate be made of conductive materials such as metal, as desired in some situations.

According to the U.S. Pat. No. 4,979,907, to improve the above types of outlet strip assemblies, the invention shown therein has made improvements by further separating or detaching the receptacles from the cover plate and by providing a linking means between the multiple receptacle means and the base. It is noted that with the receptacles, or so called multiple receptacle means referred to hereinafter in this disclosure, and the cover plate thus separately provided, the adaptability of the outlet strip assembly is enhanced; in particular, the cover plate can be fabricated of a conductive material such as metal. This specific feature is not present if the cover plate and the receptacles are integrally formed by injection molding. Also, the cover plate of the present invention can be made of a different color than the multiple receptacle means. In accordance with the invention, an improved outlet strip assembly of the type described above is not complicated in construction and easy to manufacture and assemble. Further, with the multiple receptacle means separately provided to be releasably fixed on the base but not integrally formed with the cover plate, it is possible to have all the advantages of the known types of outlet strips described above and avoids any of the drawbacks associated with each.

### SUMMARY OF THE INVENTION

The present invention concerns a power strip including: a base unit having a plurality of electrical outlets; a first cover portion receiving the base unit, the first cover portion having formed therein a plurality of apertures each receiving and exposing an associated one of the outlets; and a second cover portion receiving the base unit and being releasably attached to the first cover portion, the first and second cover portions cooperating to substantially enclose the base unit.

The first and second cover portions can be releasably attached by fastener means such as a snap fit fastener means. The base unit can include a surge suppressor module. The base unit can include at least one signal connector and one of the first and second cover portions then includes a connector aperture formed therein exposing the at least one signal connector. The base unit has a housing and the first and second cover portions cooperate to form a shape that is different from a shape of said housing. The base unit can include a line cord, a circuit breaker, an indicator light and an on/off switch and at least one of said first and second cover portions has formed therein corresponding openings exposing the line cord, the circuit breaker, the indicator light and said on/off switch.

The power strip according to the present invention includes: at least a pair of base units, each of the base units including at least one of an electrical outlet and a signal connector; a first cover portion receiving at least one of the base units and including an aperture formed therein for exposing the at least one of an electrical outlet and a signal connector; and a second cover portion receiving at least one of the base units and including an aperture formed therein for exposing the at least one of an electrical outlet and a signal connector, the second cover portion being attached to the first cover portion. The base unit can include at least two modules electrically and mechanically connected together, each said module having at least one of an electrical outlet and a signal connector. The modules can include a quick connect means having a male portion on one of the modules and a cooperating female portion on another of the modules. The base unit can include at least one rail subassembly having a plurality of rails extending between end walls thereof and at least two modules having contacts electrically connecting to the rails.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIGS. 1a-1c are perspective views, respectively, of an outlet strip base unit, an interchangeable cover and the assembly in accordance with the present invention;

FIGS. 2a-2d are perspective views, respectively, of an alternative embodiment in accordance with the present invention of an outlet strip base unit, an interchangeable cover, during assembly/disassembly and the assembly;

FIGS. 3a-3d are perspective views, respectively, of another alternative embodiment in accordance with the present invention of an outlet strip base unit, an interchangeable cover, during assembly/disassembly and the assembly;

FIGS. 4a-4d are fragmentary perspective views, respectively, of a third alternative embodiment in accordance with the present invention of an outlet strip base unit, an interchangeable cover, during assembly/disassembly and the assembly;

FIGS. 5a-5e are perspective views, respectively, of a fourth alternative embodiment in accordance with the present invention of a first outlet strip base unit, a second outlet strip base unit, a combined outlet strip base unit, an interchangeable cover, the assembly, an opposite end of the combined outlet strip base unit, an opposite end of the cover and an opposite end of the assembly;

FIG. 6 is a fragmentary cross-sectional view of the shells forming the cover shown in FIG. 1b;

FIGS. 7a-7f are perspective views of an outlet strip base unit, an interchangeable cover during assembly/disassembly and the assembly in accordance with a fifth alternative embodiment of the present invention;

FIGS. 7g-7m are perspective views of a sixth alternative embodiment in accordance with the present invention of a pair of outlet strip base units, an interchangeable cover during assembly/disassembly and the assembly;

FIGS. 8a-8f are perspective views of a seventh alternative embodiment in accordance with the present invention of a rail subassembly, an outlet strip base unit, an interchangeable cover, during assembly/disassembly and the assembly;

FIGS. 9a-9e are fragmentary perspective views of an eighth alternative embodiment in accordance with the present invention of a rail subassembly, an outlet strip base unit, an interchangeable cover, during assembly/disassembly and the assembly;

FIGS. 10a-10e are perspective views, respectively, of a ninth alternative embodiment in accordance with the present invention of invention of a rail subassembly, an outlet strip base unit, an interchangeable cover, during assembly/disassembly and the assembly; and

FIG. 11 is an exploded perspective view of an alternate embodiment base unit for use with the cover according to the present invention.

### DESCRIPTION OF THE PREFERRED EMBODIMENT

U.S. Pat. No. 6,755,676 issued Jun. 29, 2004, U.S. provisional patent application Ser. No. 60/680,207 filed May 12, 2005 and U.S. provisional patent application Ser. No. 60/712,547 filed Aug. 30, 2005 are hereby incorporated herein by reference.

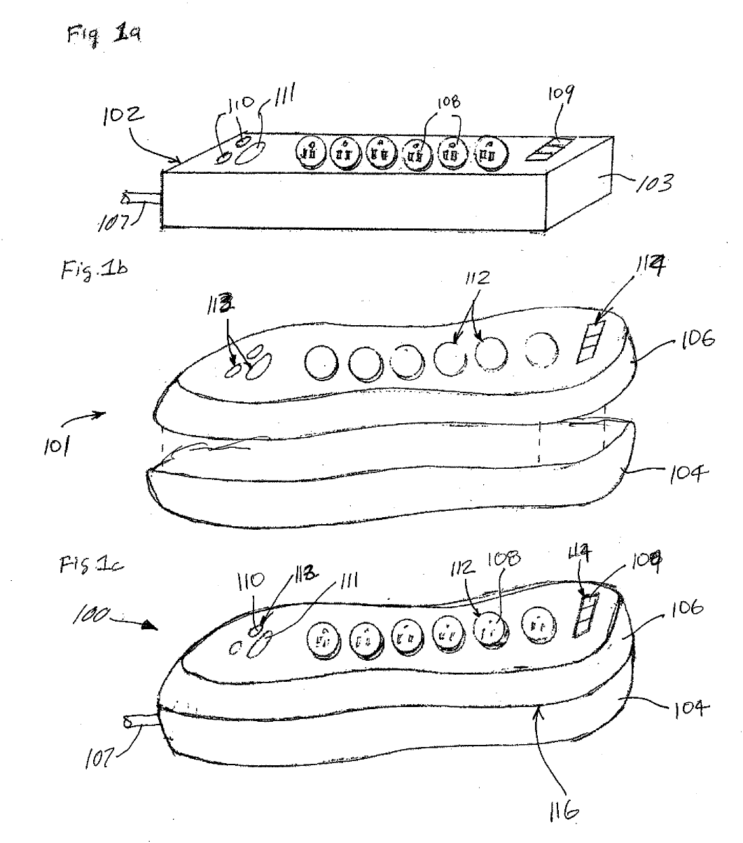

Referring now to FIGS. 1a-1c, an interchangeable cover outlet strip assembly in accordance with the present invention is shown in FIG. 1c and is indicated generally at 100. The assembly 100 includes a two piece cover 101 and a common base unit 102. The cover 101 is separable into two portions; a lower shell half 104, and an upper shell half 106. The base unit 102 includes a housing 103 that has on an upper surface thereof at least one and preferably a plurality of standard electrical outlets 108 of the type that receive a plug on the end of a power cord connected to a device (not shown). The outlets 108 may be disposed alternatively on any surface of the housing 103 depending upon the orientation of the assembly 100 during use. The outlets 108 are provided with electrical power by a power cord 107 extending from the housing 103 and adapted to be plugged into a standard wall outlet. One or more signal connectors 109 are provided on the housing 103 including, but are not limited to, telephone jacks, network (i.e. RJ11 or the like) jacks, coaxial connectors, and the like. The base unit 102 may also include indicators 110 and an on/off switch 111. The switch 111 controls the connection of the outlets 108 to the power cord 107. The indicators 110 can include lamps that indicate the state of the switch 111 and, in some cases, the status of surge protection circuitry inside the housing 103 for protecting the outlets 108 and the connectors 109. The indicators 110 also can include a reset button for an internal circuit breaker.

The lower shell half 104 is cup-shaped and is adapted to conform with and receive the lower surface of the housing 103. The upper shell half 106 is inverted cup-shaped and includes a plurality of apertures 112 formed therethrough that receive and expose associated ones of the outlets 108 as shown in FIG. 1c. Also provided are apertures 113 for the lamps 110 and the switch 111 and an aperture(s) 114 for the connectors 109. The shell halves 104 and 106 receive the base unit 102 and are attached to one another, preferably along peripheral edges 116 thereof to enclose the base unit 102. When attached to the base unit 102, the shell halves 104 and 106 form an outer housing that provides a different ornamental appearance for the base unit 102.

Preferably, the housing halves 104 and 106 are attached by a snap fit using any suitable fastening means as described below. The fastening means can be fixed or releasable. Alternative releasable fasteners could include, but are not limited to, clips, tangs, spring-loaded release projections and the like (not shown) while remaining within the scope of the present invention as will be appreciated by those skilled in the art.

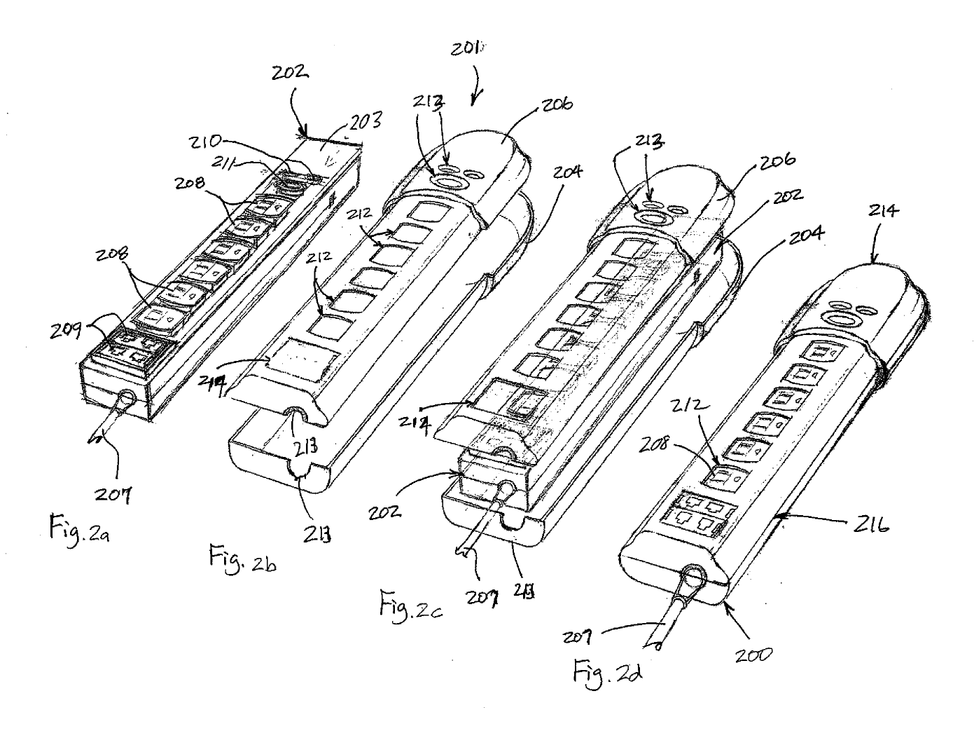

Referring now to FIGS. 2a-2d, an alternative embodiment of an interchangeable cover outlet strip assembly in accordance with the present invention is indicated generally at 200. In FIGS. 2a-2d parts of the assembly 200 corresponding to the parts of the assembly 100 shown in FIGS. 1a-1c are designed by corresponding reference numerals in the “200” range. The cover 201 has a different ornamental appearance and four of the connectors 209 are provided. The only other difference is that an aperture 213 is shown formed in an end of the shells 204 and 206 for receiving the power cord 207. A similar aperture (not shown in FIGS. 1a-1c) is provided in the shells 104 and 106 for the power cord 107.

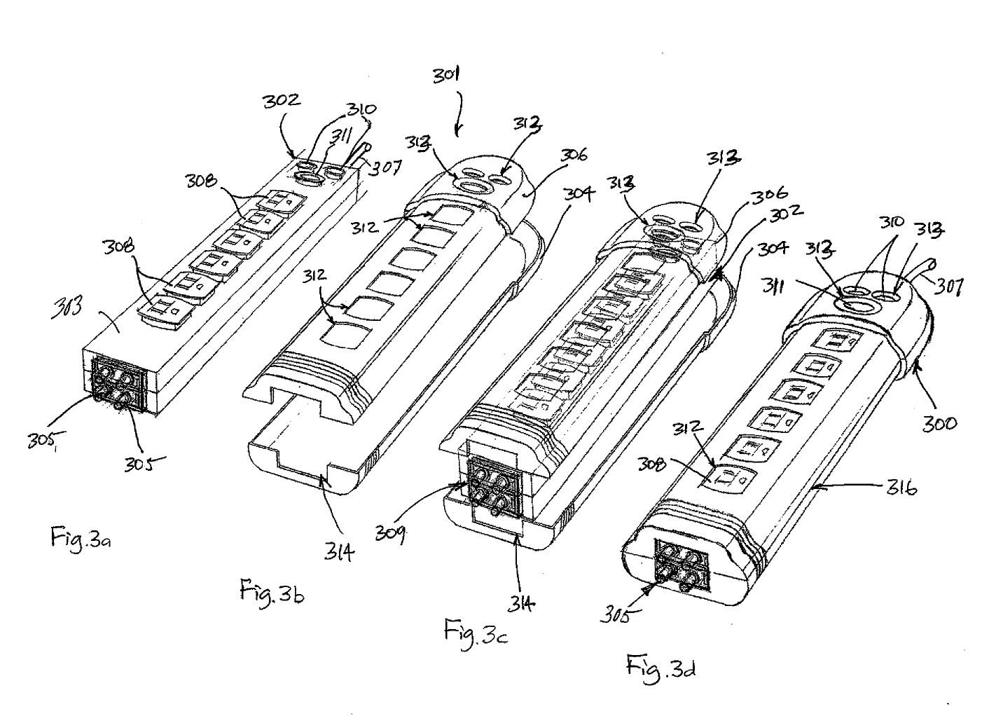

Referring now to FIGS. 3a-3d, a second alternative embodiment of an interchangeable cover outlet strip assembly in accordance with the present invention is indicated generally at 300. In FIGS. 3a-3d parts of the assembly 300 corresponding to the parts of the assemblies 100 and 200 are designed by corresponding reference numerals in the “300” range. The cover 301 has a different ornamental appearance than the covers 101 and 201 and four coaxial connectors 305 are provided in an end wall of the housing 303 and are received in an aperture 314 in the cover 301.

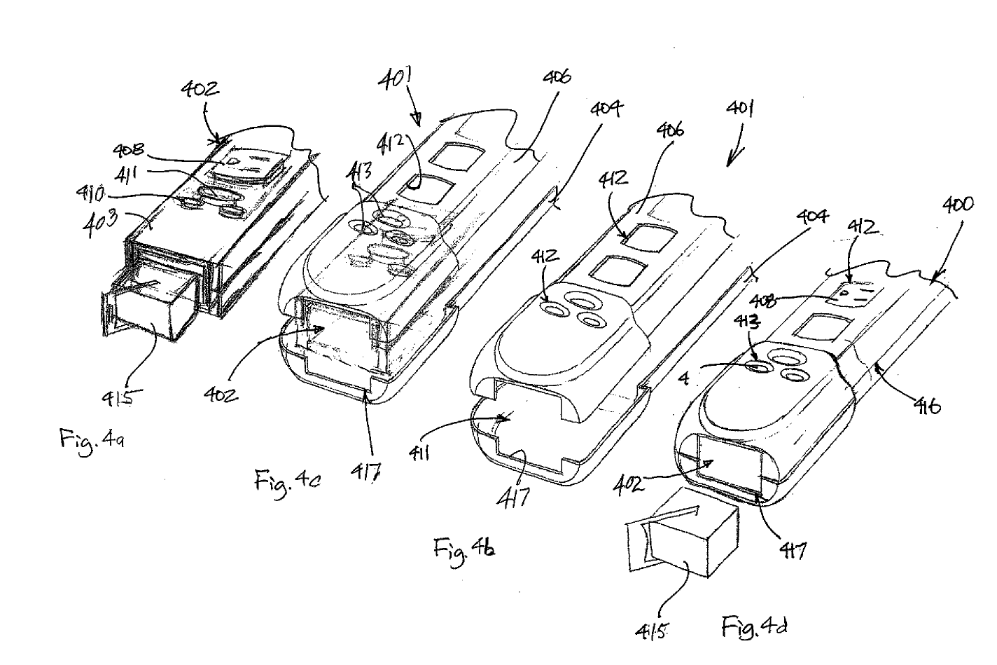

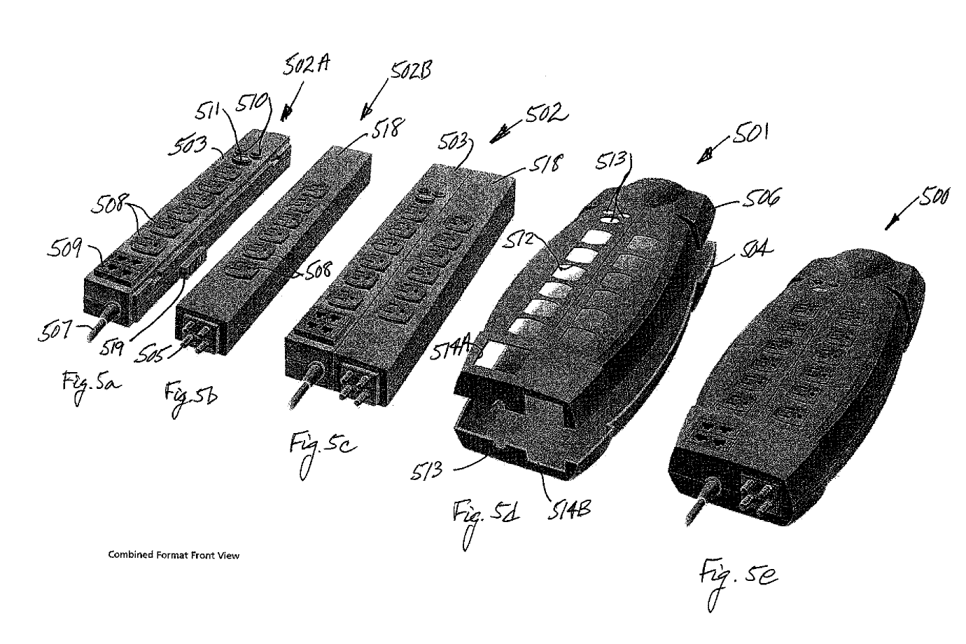

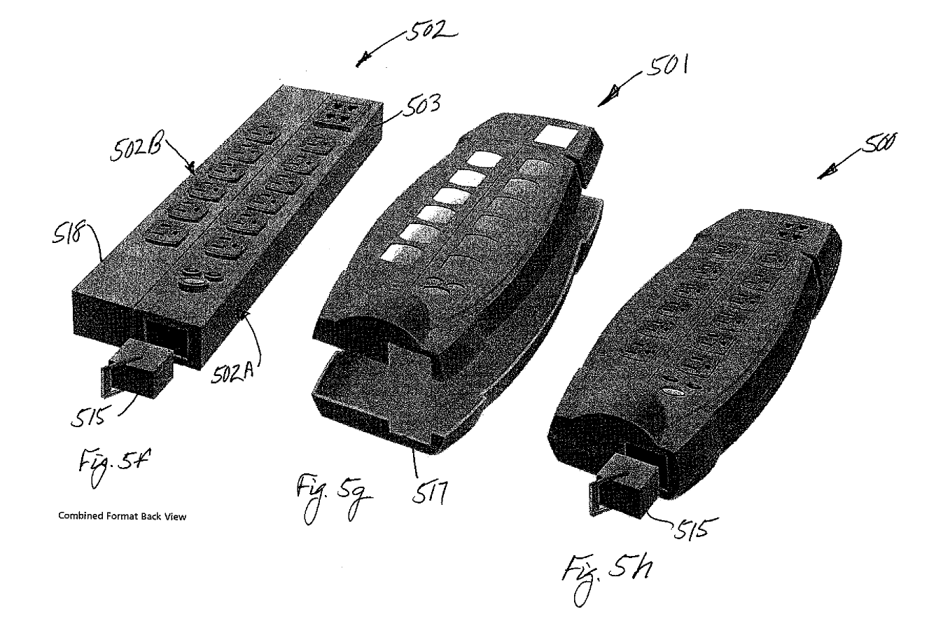

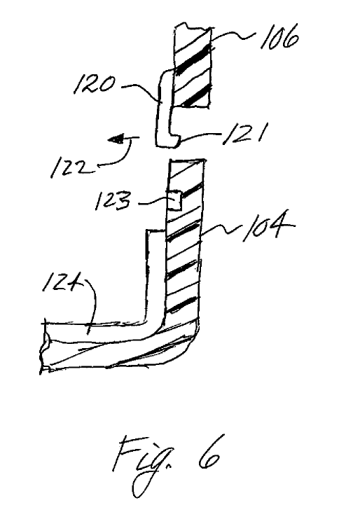

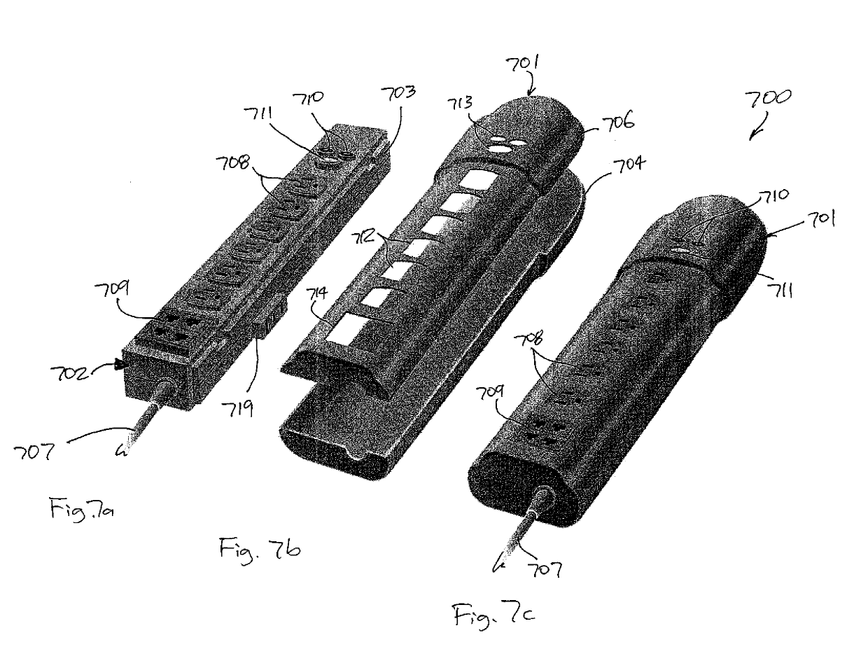

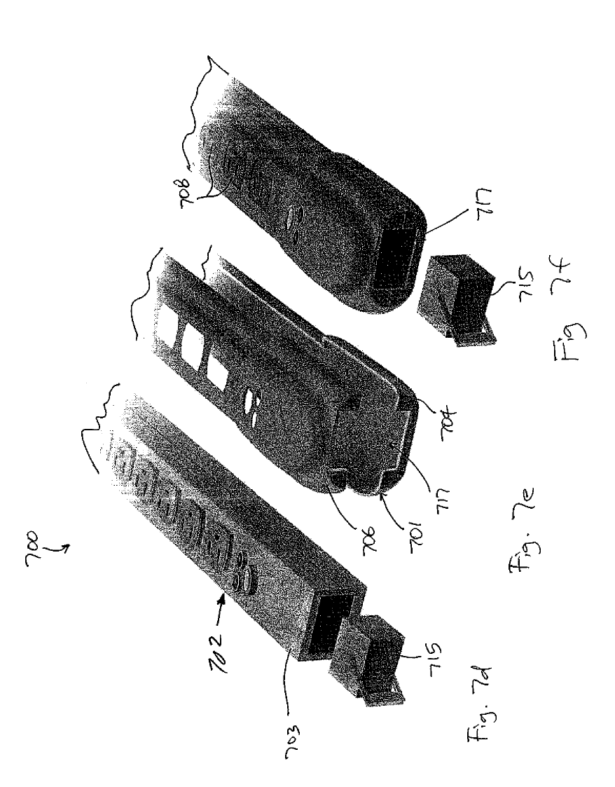

Referring now to FIGS. 4a-4d, a third alternative embodiment of an interchangeable cover outlet strip assembly in accordance with the present invention is indicated generally at 400. In FIGS. 4a-4d parts of the assembly 400 corresponding to the parts of the assemblies 100, 200 and 300 are designed by corresponding reference numerals in the “400” range. The cover 401 has a different ornamental appearance than the covers 101, 201 and 301 and a removable surge suppressor module 415 is provided in an end wall of the housing 403 and is received in an aperture 417 in the cover 401.

Referring now to FIGS. 5a-5h, a fourth alternative embodiment of an interchangeable cover outlet strip assembly in accordance with the present invention is indicated generally at 500. In FIGS. 5a-5h parts of the assembly 500 corresponding to the parts of the assemblies 100, 200, 300 and 400 are designed by corresponding reference numerals in the “500” range. The cover 501 has a different ornamental appearance than the covers 101, 201, 301 and 401 and provides two rows of the outlets 508. A first base unit 502A is similar to the base unit 202 and includes a removable surge suppressor module 515. A second base unit 502B has a plurality of the outlets 508 and the coaxial connectors 505. An interface connector 519 is provided on a side of the housing 503 for electrical connection with a complementary connector (not shown) on the side of the housing 518. Thus, electrical power from the power cord 507 is connected to the outlets 508 on the housing 518 when the interface connectors are mated as shown in FIG. 5c.

The base units 102, 202, 302, 402 and 502 can be used with different covers having various ornamental features. Thus, the same base unit could be provided to different retailers with different cover designs. Also, the base unit could be sold with the customer choosing from two or more cover designs to be assembled by the customer.

The fastener means for attaching the two shells of the various covers described above can take many forms. If the shells are to be permanently attached, an adhesive, ultrasonic welding, or metal or plastic rivets could be used. Fastener means that permit the shells to be separated can include screws and snaps. For example, there is shown in FIG. 6 an arm 120 extending downwardly from an inner surface of the upper shell 106. An outwardly extending finger 121 is provided on the free end of the arm 120. As the upper shell 106 and the lower shell 104 are moved toward one another, the finger 121 engages the upper edge of the lower shell 104 and the arm 120 is deflected inwardly in the direction of an arrow 122. This permits the finger 121 to be moved downwardly along an inner surface of the lower shell 104 until the finger 121 is free to snap into a cavity 123 formed in the wall of the lower shell 104. The arm 120, the finger 121 and the cavity 123 are representative of a plurality of such fastener means spaced about the cover 101.

Also shown in FIG. 6 is a rib 124 extending inwardly from the inner surface of the lower shell 104. The rib 124 is representative of a support and positioning means, which can be a plurality of such ribs, for retaining the base unit 102 in position inside the cover 101.

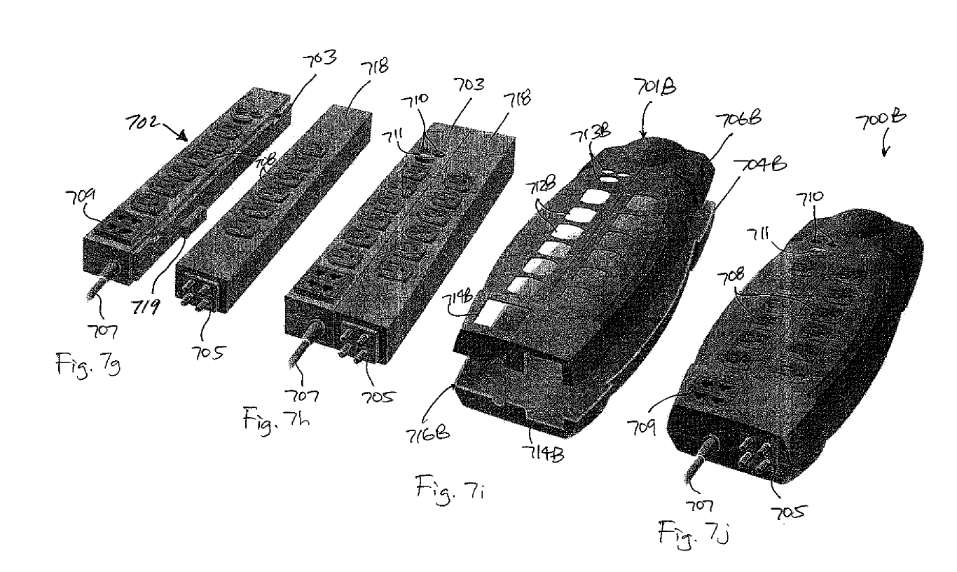

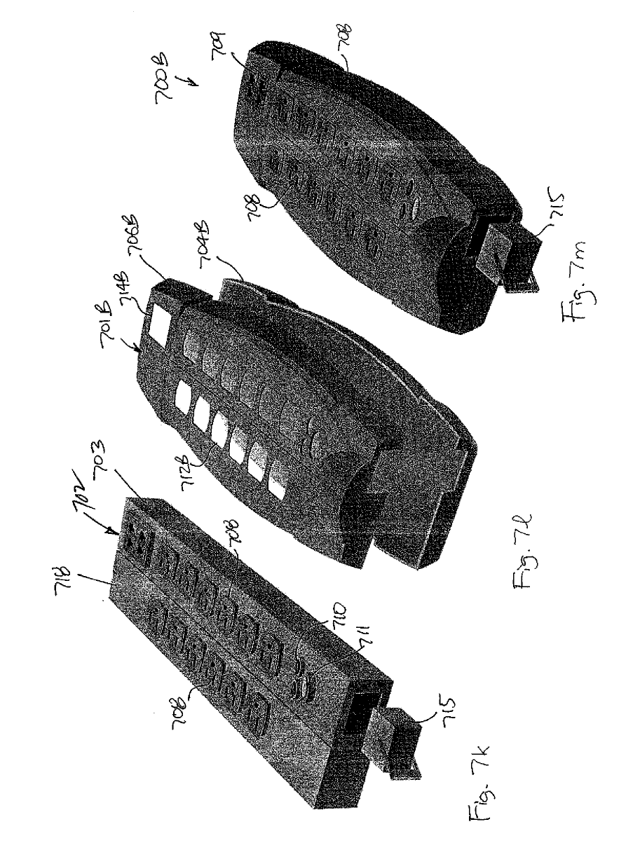

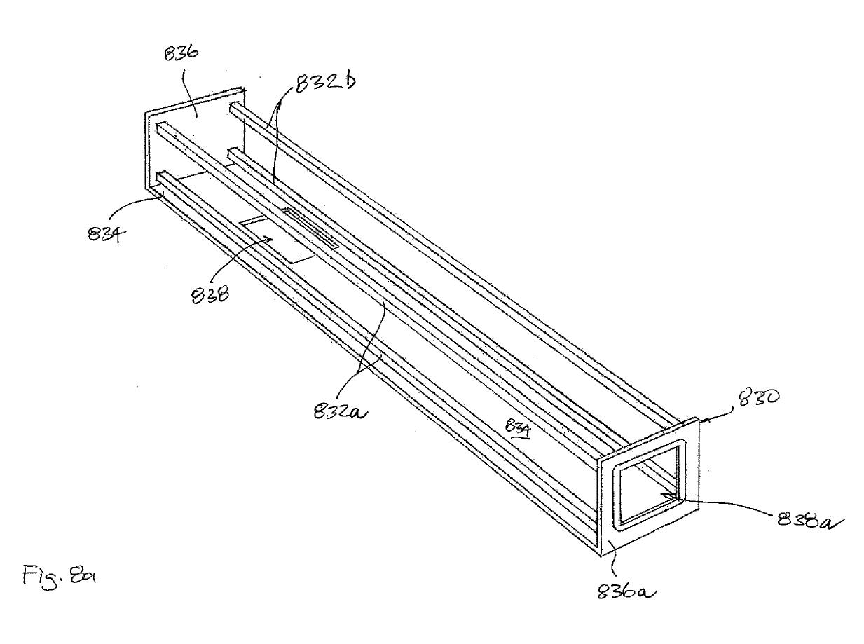

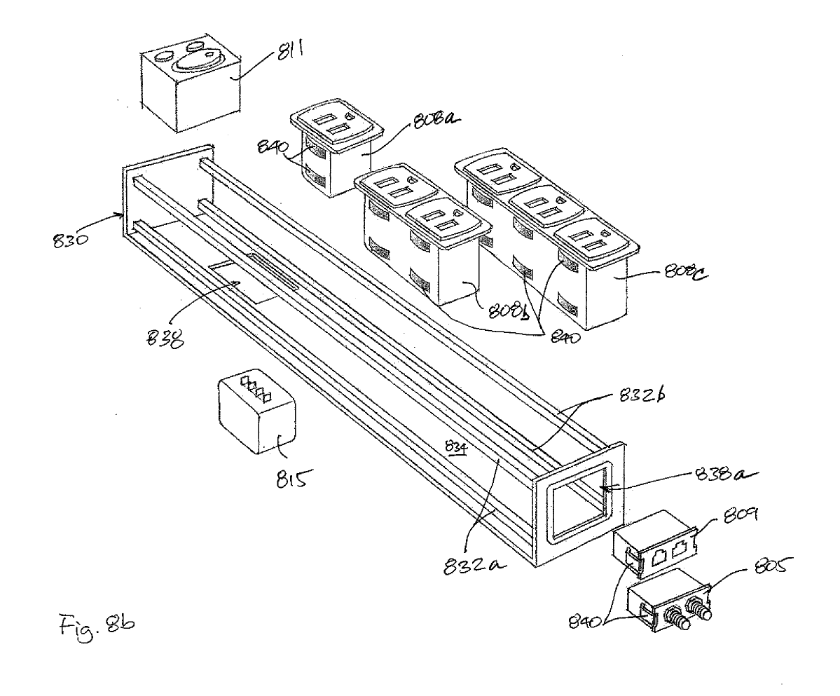

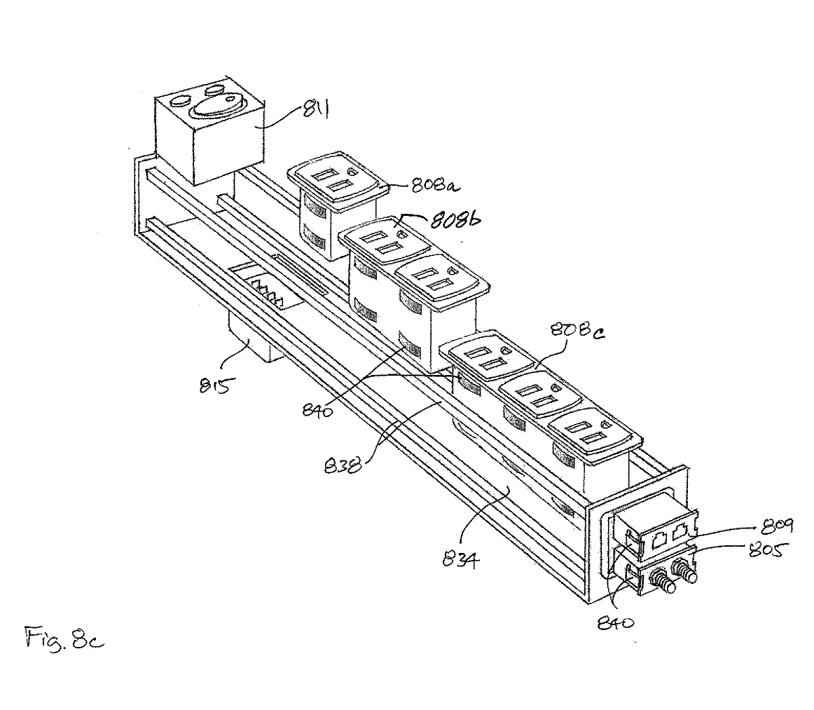

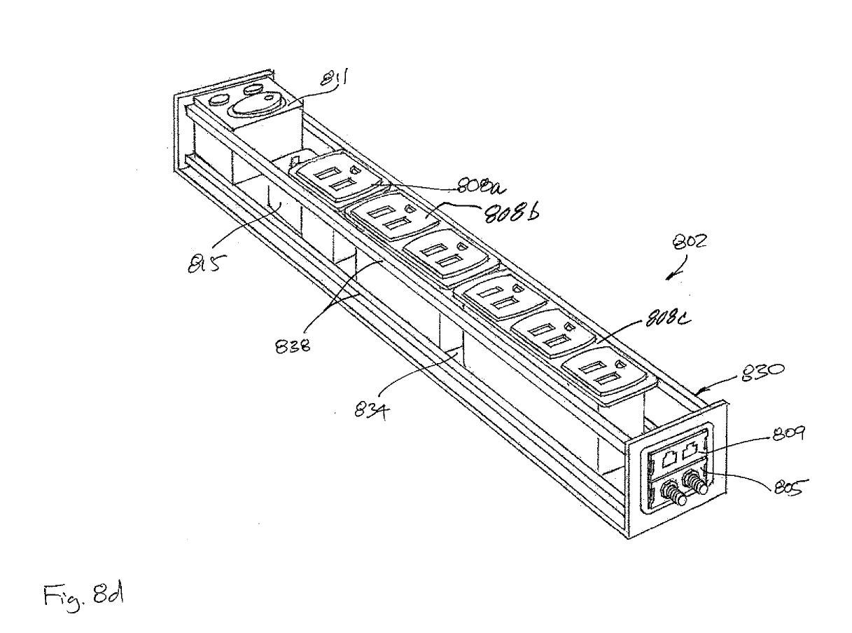

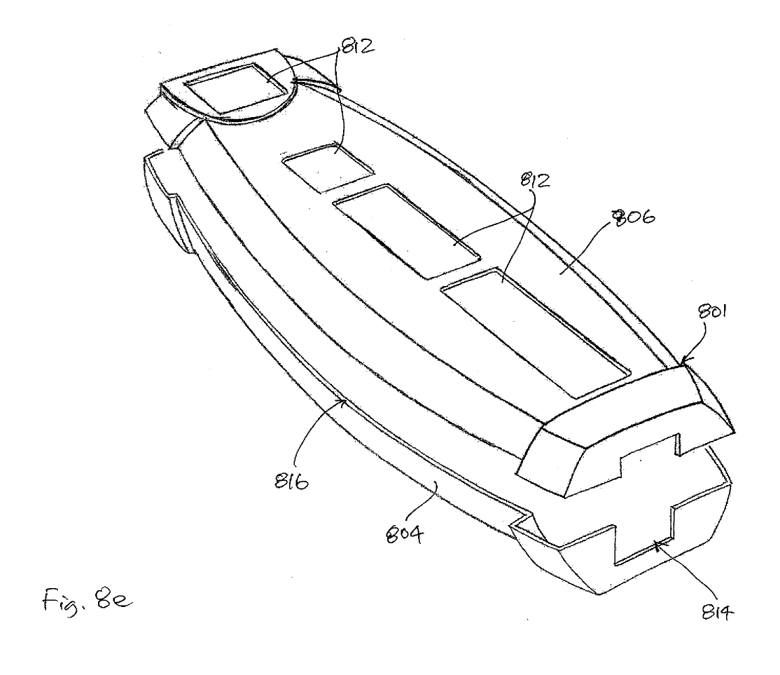

Referring now to FIGS. 7a-7f, an interchangeable cover outlet strip assembly in accordance with a fifth alternative embodiment of the present invention is shown in FIG. 7c and is indicated generally at 700. The assembly 700 includes a two piece cover 701 and a common base unit 702. The cover 701 is separable into a lower shell half 704, and an upper shell half 706. The base unit 702 includes a housing 703 that has on an upper surface thereof at least one and preferably a plurality of standard electrical outlets 708 of the type that receive a plug on the end of a power cord connected to a device (not shown). The outlets 708 may be disposed alternatively on any surface of the housing 703 depending upon the orientation of the assembly 700 during use. The outlets 708 are provided with electrical power by a power cord 707 extending from the housing 703 and adapted to be plugged into a standard wall outlet. One or more signal connectors 709 are provided on the housing 703 including, but are not limited to, telephone jacks, network (i.e. RJ11 or the like) jacks, coaxial connectors, and the like. The base unit 702 may also include indicators 710 and an on/off switch 711. The switch 711 controls the connection of the outlets 708 to the power cord 707. The indicators 710 can include lamps that indicate the state of the switch 711 and, in some cases, the status of surge protection circuitry inside the housing 703 for protecting the outlets 708 and the connectors 709. The indicators 710 also can include a reset button for an internal circuit breaker. A removable surge suppressor module 715, best seen in FIGS. 7d and 7f, is provided in an end wall of the housing 703 and is received in an aperture 717, best seen in FIG. 7e, in the cover 701. An interface power connector 719 is provided on a side of the housing 703 for electrical connection with a complementary connector (not shown) on the side of a second base unit (not shown).

The lower shell half 704 is cup-shaped and is adapted to conform with and receive the lower surface of the housing 703. The upper shell half 706 is inverted cup-shaped and includes a plurality of apertures 712 formed therethrough that receive and expose associated ones of the outlets 708 as shown in FIG. 7c. Also provided are apertures 713 for the lamps 710 and the switch 711 and an aperture(s) 714 for the connectors 709. The shell halves 704 and 706 receive the base unit 702 and are attached to one another, preferably along peripheral edges 716 thereof to enclose the base unit 702. When attached to the base unit 702, the shell halves 704 and 706 form an outer housing that provides a different ornamental appearance for the base unit 702.

Preferably, the housing halves 704 and 706 are attached by a snap fit using any suitable fastening means as previously described. The fastening means can be fixed or releasable. Alternative releasable fasteners could include, but are not limited to, clips, tangs, spring-loaded release projections and the like (not shown) while remaining within the scope of the present invention as will be appreciated by those skilled in the art.

Referring now to FIGS. 7g-7m, a sixth alternative embodiment of an interchangeable cover outlet strip assembly in accordance with the present invention is shown in FIG. 7j and 7m and is indicated generally at 700B. The assembly 700B includes a two piece cover 701B, the base unit 702, and a second base unit 702B. The cover 701B is separable into a lower shell half 704B, and an upper shell half 706B. The second base unit 702B includes a housing 718 with a plurality of the outlets 708 and a plurality of coaxial connectors 705 provided in an end wall of the housing 718. The interface power connector 719 on the side of the housing 703 makes an electrical connection with a complementary power connector (not shown) on the side of the housing 718. Thus, electrical power from the power cord 707 is connected to the outlets 708 on the housing 718 when the interface power connectors are mated as shown in FIG. 7h and 7j.

The lower shell half 704B is cup-shaped and is adapted to conform with and receive the lower surface of the housings 703 and 718. The upper shell half 706B is inverted cup-shaped and includes a plurality of apertures 712B formed therethrough that receive and expose associated ones of the outlets 708 as shown in FIG. 7j. Also provided are apertures 713B for the lamps 710 and the switch 711 and an aperture(s) 714 for the connectors 705 and 709. The shell halves 704B and 706B receive the base units 702 and 702B and are attached to one another, preferably along peripheral edges 716 thereof to enclose the base units 702 and 702B. When attached to the base units 702 and 702B, the shell halves 704 and 706 form an outer housing that provides a different ornamental appearance for the base units 702 and 702B.

Thus, those skilled in the art will appreciate that the base unit 702 may be advantageously used as a single power strip, as shown in FIGS. 7c and 7f, or as a double power strip, in combination with the second base unit 702B, as shown in FIGS. 7j and 7m.

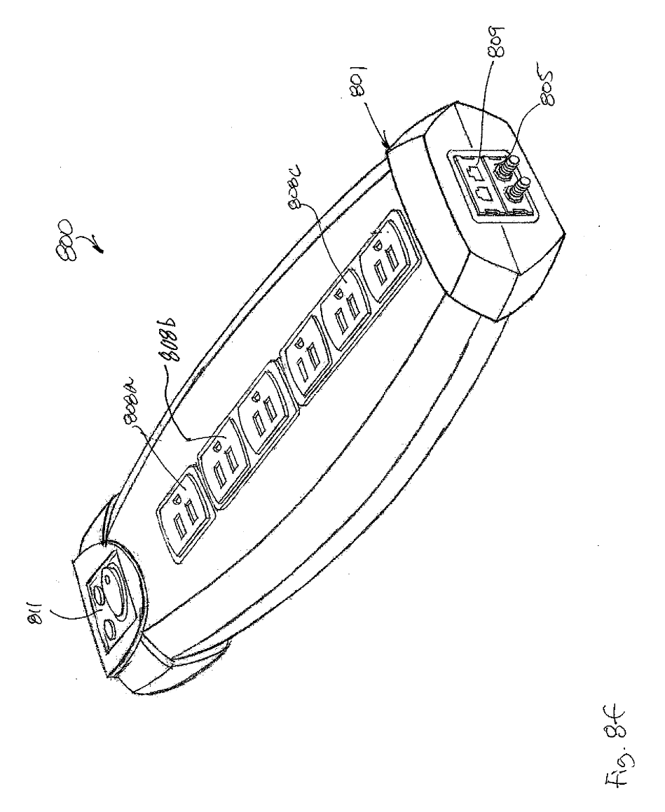

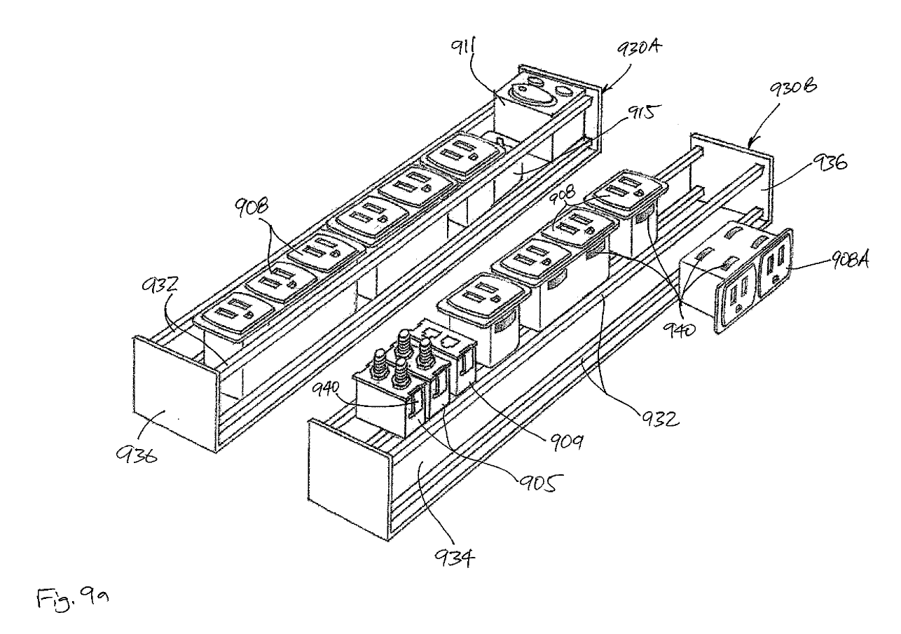

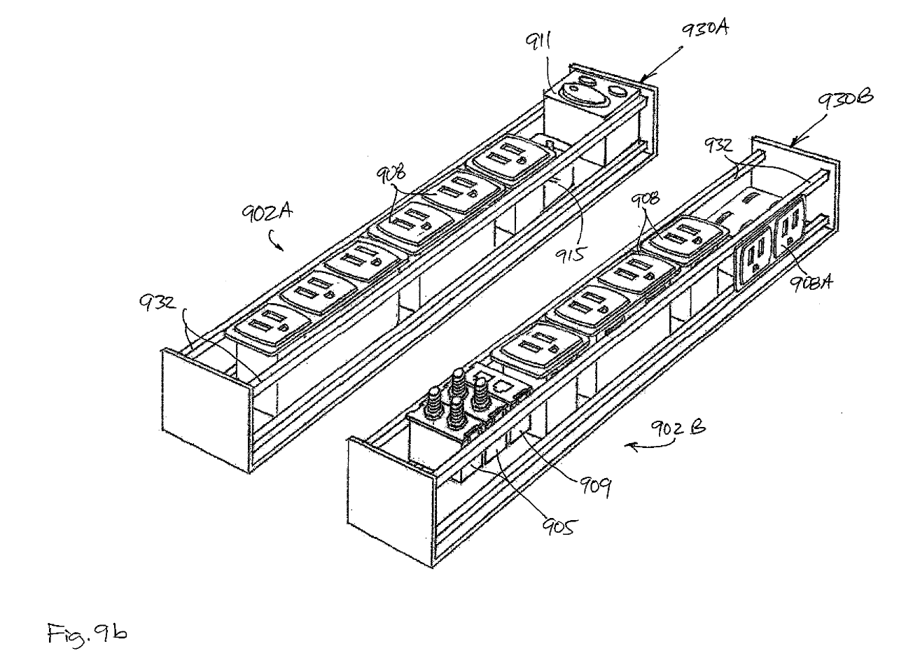

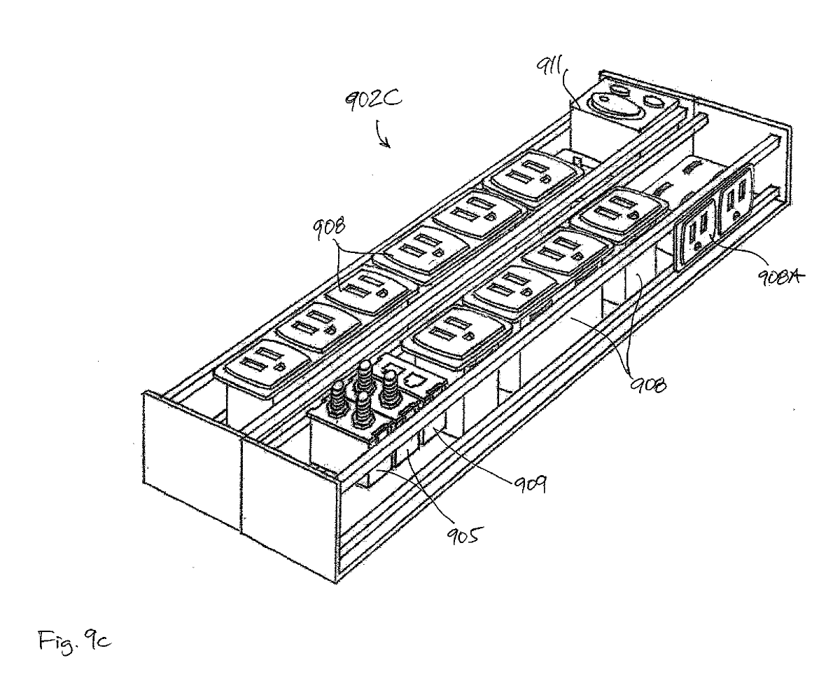

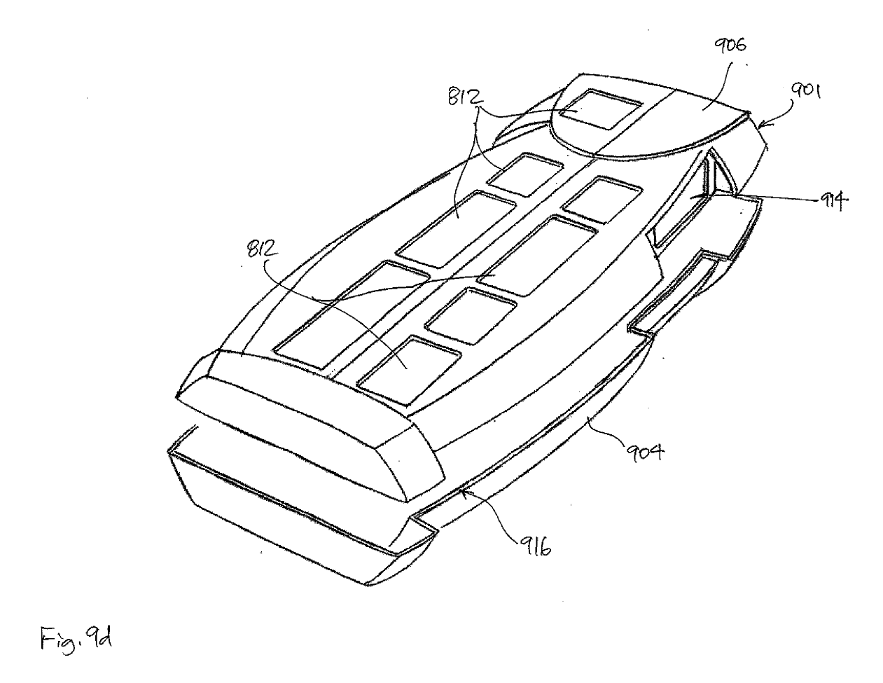

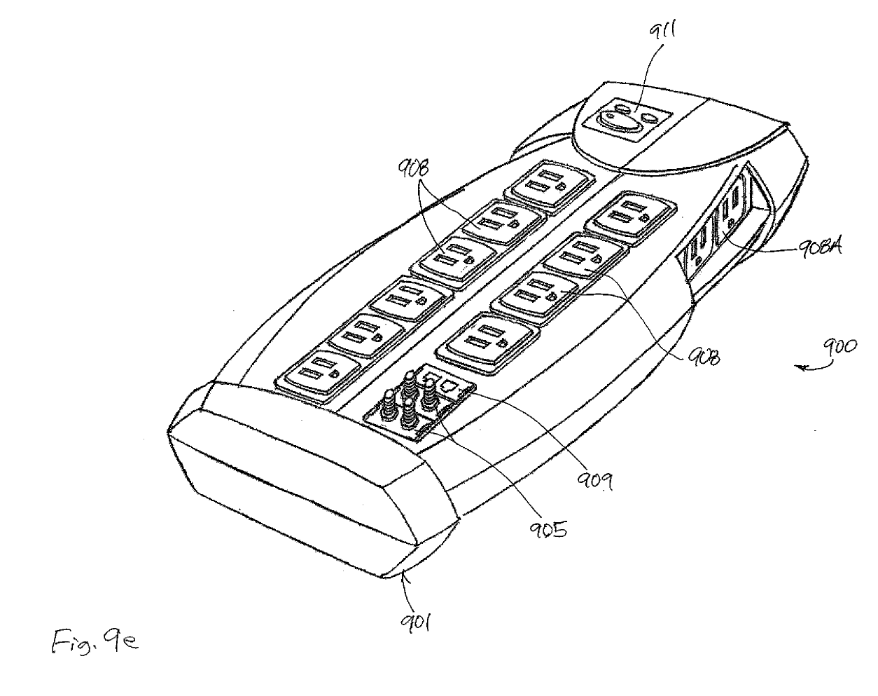

Referring now to FIGS. 8a-8f, a seventh alternative embodiment of an interchangeable cover outlet strip assembly in accordance with the present invention is shown in FIG. 8f and is indicated generally at 800. The assembly 800 includes a rail subassembly 830 having a plurality of rail members 832a and 832b, and a bottom side wall 834 extending between a pair of end walls 836 and 836a. An aperture 838 may be provided in the side wall 834 and an aperture 838a may be provided in the end wall 836a.

The rail subassembly 830 is adapted to receive and retain in position a plurality of modules (as shown in FIG. 8b) including a coaxial connector module 805, a signal connector module 809, a plurality of outlet modules 808a, 808b and 808c, and a switch module 811 that includes a switch and indicator, such as the indicator 710 and the switch 711 shown in the assembly 700. The outlet module 808a has one receptacle, the outlet module 808b has two receptacles and the outlet module 808c has three receptacles. A removable surge suppressor module 815 is received in the aperture 838 formed in the side wall 834. Each of the modules 805, 808a, 808b, 808c and 809 includes contacts 840 on an exterior surface thereof for contacting the rails 832a. The rails 832a are connected to a source of electrical power (110 Volt AC) through the switch module 811 to provide electrical power to the modules 805, 808a, 808b, 808c and 809, through their respective contacts 840. Although not shown, the modules 805, 808a, 808b, 808c and 809 are provided with another of the contacts 840 on the opposite sides to contact one of the rails 832b for grounding. The modules 805, 808, 809, 811, and 815 and the rail subassembly 830, when attached, form a base unit 802 (see FIG. 8d).

The assembly 800 includes a two piece cover 801 that is separable into a lower shell half 804 and an upper shell half 806. The lower shell half 804 is cup-shaped and is adapted to conform with and receive the lower surface of the base unit 802. The upper shell half 806 is inverted cup-shaped and includes a plurality of apertures 812 formed therethrough that receive and expose associated ones of the outlet modules 808a, 808b and 808c and the switch module 811 as shown in FIG. 7c. Also provided are apertures 813 for the lamps and the switch of the switch module 811 and an aperture(s) 814 for the connectors 805 and 809. The shell halves 804 and 806 receive the base unit 802 and are attached to one another, preferably along peripheral edges 816 thereof to enclose the base unit 802. When attached to the base unit 802, the shell halves 804 and 806 form an outer housing that provides a different ornamental appearance for the base unit 802.

Referring now to FIGS. 9a-9e, an eighth alternative embodiment of an interchangeable cover outlet strip assembly in accordance with the present invention is indicated generally at 900. In FIGS. 9a-9d parts of the assembly 900 corresponding to the parts of the assembly 800 are designed by corresponding reference numerals in the “900” range. The assembly 900 includes a pair of rail subassemblies 930A and 930B that form respective base units 902A and 902B. The base units 902A and 902B are attached to form a combined base unit 902C. An outlet module 908A is mounted in the rail subassembly 930B transverse with respect to the other outlet modules 908 and preferably contacts all of the rails 932. A pair of the coaxial connector modules 905 and the connector module 909 are mounted facing the same direction as the outlet modules 908. The only other difference is that the cover 901 has a different ornamental appearance than the cover 801.

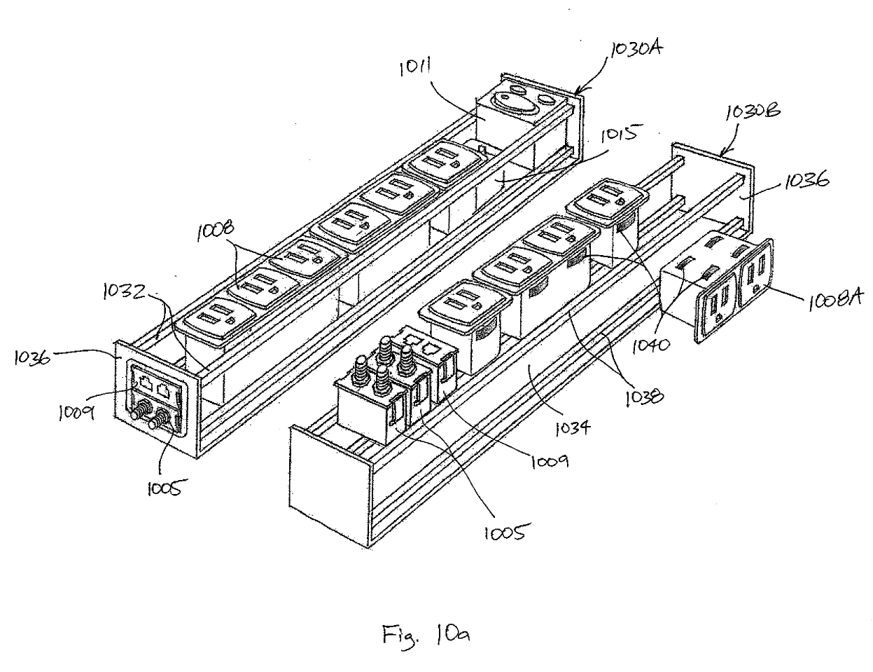

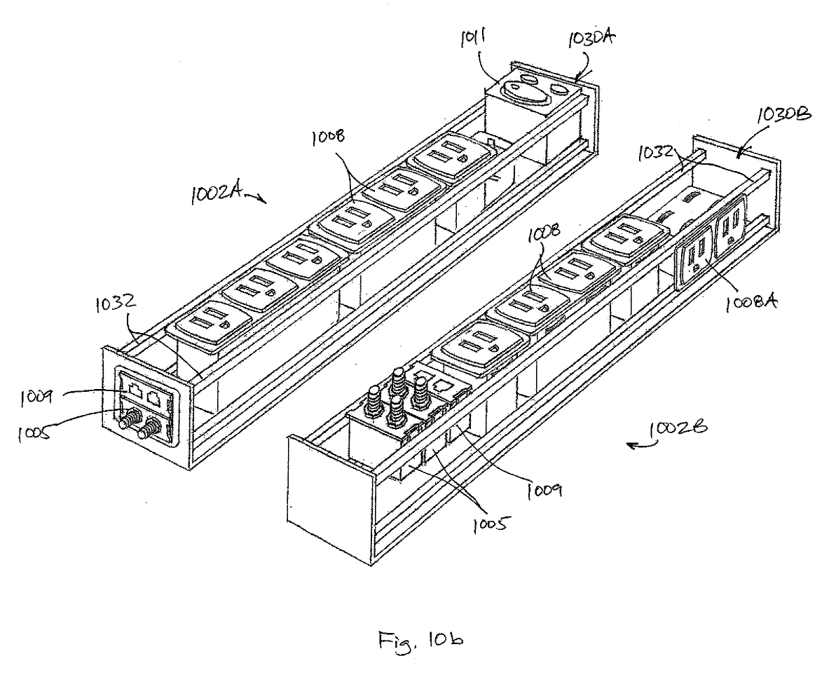

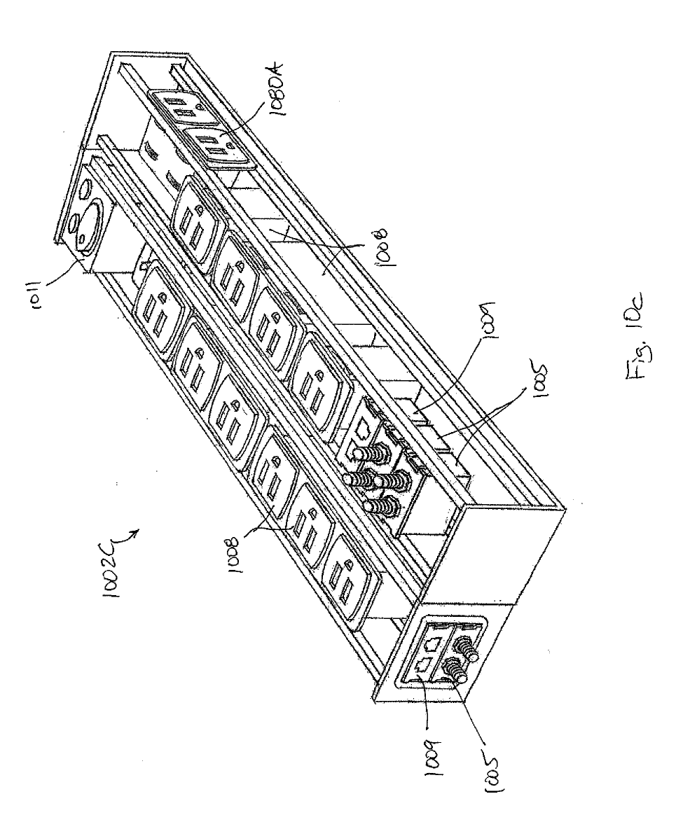

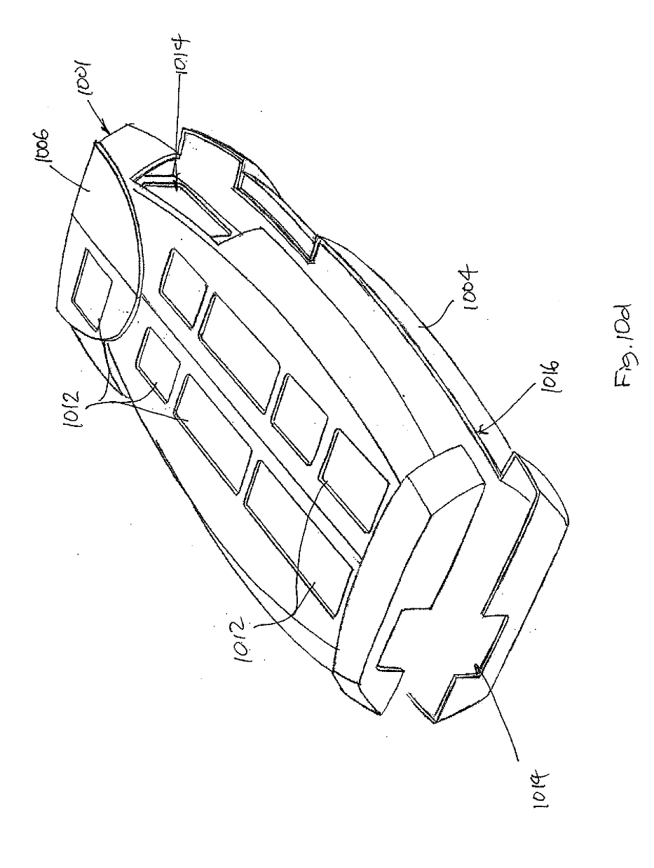

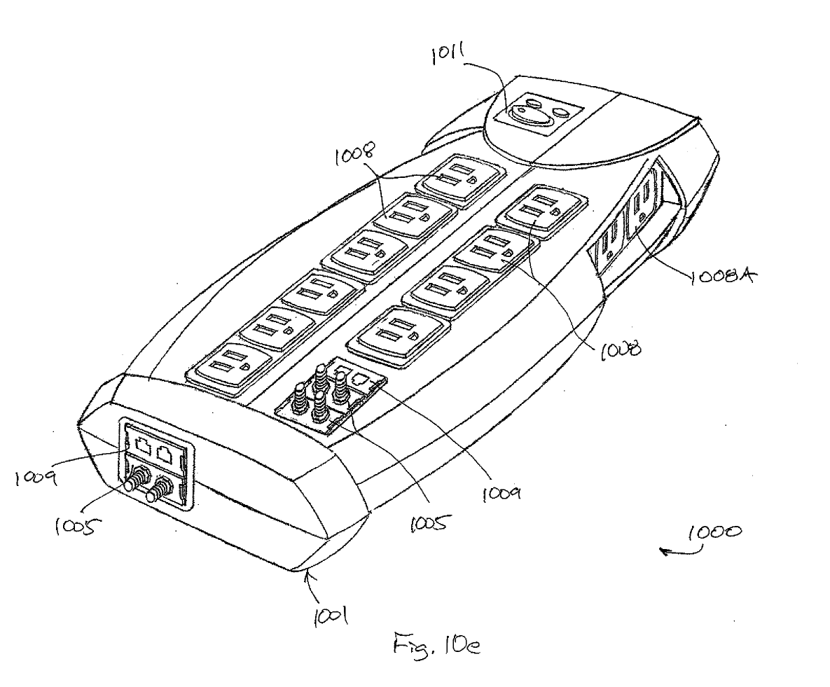

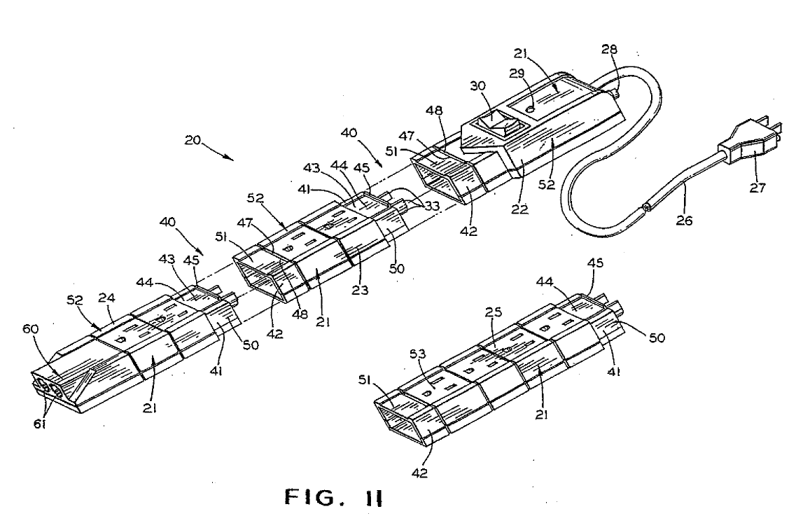

Referring now to FIGS. 10a-10e, a ninth alternative embodiment of an interchangeable cover outlet strip assembly in accordance with the present invention is indicated generally at 1000. In FIGS. 10a-10e parts of the assembly 1000 corresponding to the parts of the assemblies 800 and 900 are designed by corresponding reference numerals in the “1000” range. The cover 1001 has a different ornamental appearance than the covers 801 and 901 and a coaxial connector module 1005 and a connector module 1009 are provided in an end wall of the rail subassembly 1030A and are received in an aperture 1014 in the cover 1001.

The fastener means for attaching the two shells of the various covers described above can take many forms. If the shells are to be permanently attached, an adhesive or ultrasonic welding could be used. Fastener means that permit the shells to be separated can include screws and snaps. For example, there is shown in FIG. 6 an arm 120 extending downwardly from an inner surface of the upper shell 106. An outwardly extending finger 121 is provided on the free end of the arm 120. As the upper shell 106 and the lower shell 104 are moved toward one another, the finger 121 engages the upper edge of the lower shell 104 and the arm 120 is deflected inwardly in the direction of an arrow 122. This permits the finger 121 to be moved downwardly along an inner surface of the lower shell 104 until the finger 121 is free to snap into a cavity 123 formed in the wall of the lower shell 104. The arm 120, the finger 121 and the cavity 123 are representative of a plurality of such fastener means spaced about the cover 101.

Also shown in FIG. 6 is a rib 124 extending inwardly from the inner surface of the lower shell 104. The rib 124 is representative of a support and positioning means, which can be a plurality of such ribs, for retaining the base unit 102 in position inside the cover 101.

The base units 102, 202, 302, 402, 502 and 702 have been shown and described as having either a single housing or two side-by-side housings. However, these base units could be of the modular type shown in U.S. Pat. No. 6,755,676 incorporated herein by reference. In this manner, various covers having different lengths and numbers of apertures could be proved and all would use the same power supply modules to assemble the corresponding base unit.

Referring now to FIG. 11, which corresponds to FIG. 1 in U.S. Pat. No. 6,755,676, there is shown an exploded perspective view of the modular surge protector of the present invention, generally designated by the numeral 20. The modular surge protector 20 consists of one or more modules 21, such as a power distribution module 22, a two receptacle module 23, a modern surge protector module 24, and a four receptacle module 25.

The power distribution module 22 typically has a line cord 26 terminating in a plug 27 for connection to a source of line current. The plug 27 maybe a two-prong or three-prong plug or other plug as desired. For purposes of illustration, there is shown a standard, three conductor, polarized connector or grounding plug, although it is to be understood that whatever type of line current the surge protector is to be used on, will dictate the particular term of the plug.

Also found on the power distribution module 22 is a circuit breaker 28, an indicator light 29, and an on/off switch 30.

The line cord 26 is electrically connected seriatim to the circuit breaker 28 the indicator light 29 and the on/off switch 30 before terminating at a standard female power transfer connector or receptacle (not shown). The female receptacle has a plurality of appropriately shaped receptors (not shown) to receive a plurality of like shaped male connectors 33 carried by a male power transfer connector on the module 23.

The various modules 21 are connected by quick connect means, generally designated by the numeral 40. Each of the quick connect means 40 contains a male portion 41 and a female portion 42. In FIG. 11, the male portion 41 has a retainer means 43 in the form of a tab 44 having an upstanding ridge portion 45, while the female portion 42 of the quick connect means 40 has a retaining means 47 in the form of a slot 48 which receives and retains the upstanding ridge 45 provided on the tab 44 forming a portion of the male portion 41 of the quick connect means 40. The position of the retainer means 43 and the retaining means 47 can be reversed, and they can take forms other than the tab 44 which fits in the slot 48.

In FIG. 11, the male portion 41 of the quick connect means 40 generally takes the form of a reduced housing portion 50 surrounding the male power transfer connector, while the female portion 42 of quick connect means 40 takes the form of a shroud 51 formed on the end of a housing 52. The reduced housing portion 50 of the housing 52 plugs into and is surrounded by the shroud 51. Each module 21, except the power distribution module 22, contains one or more power supply receptacles 53 into which the power line cord equipment being protected is plugged.

Thus, a base unit can be assembled from the modules 21, such as the power distribution module 22, the two receptacle module 23, the surge protector module 24, and the four receptacle module 25. Once the configuration of the modular base unit is selected, the appropriate cover according to the present invention can be provided.

The covers 101, 201, 301, 401, 501, 701, 801, 901 and 1001 have been shown and described as having two portions in the form of an upper shell half and a lower shell half. However, it is contemplated that the covers could be formed otherwise. For example, there could be left and right portions or front and rear portions. The cover can be divided into two or more portions in any suitable configuration depending upon the external styling and/or the internal support and positioning means.

Use of the covers 101, 201, 301, 401, 501, 701, 801, 901 and 1001 enables a common base unit to be used with a cover in any color and/or external styling. The base unit provides all of the electrical functions associated with the power strip while the cover is ornamental and also encloses the electrical components. Thus, the cover can be formed with a shape that deviates substantially from a shape of an outer surface of the housing of the base unit. The present invention increases manufacturing efficiency by utilizing the same base unit with different covers to accommodate the desires of different retailers and/or customers.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A power strip comprising:
a base unit including a plurality of electrical outlets;
a first cover portion receiving said base unit, said first cover portion having formed therein a plurality of apertures each receiving and exposing an associated one of said outlets; and
a second cover portion receiving said base unit and being attached to said first cover portion, said first and second cover portions cooperating to substantially enclose said base unit.

2. The power strip according to claim 1 wherein said first and second cover portions are releasably attached by fastener means.

3. The power strip according to claim 2 wherein said fastener means is a snap fit fastener means.

4. The power strip according to claim 1 wherein said base unit includes a surge suppressor module.

5. The power strip according to claim 1 wherein said base unit includes at least one signal connector and one of said first and second cover portions includes a connector aperture formed therein exposing said at least one signal connector.

6. The power strip according to claim 1 wherein said base unit has a housing and said first and second cover portions cooperate to form a shape that is different from a shape of said housing.

7. The power strip according to claim 1 wherein said base unit is formed from at least two modules.

8. The power strip according to claim 1 wherein said base unit includes a line cord, a circuit breaker, an indicator light and an on/off switch and at least one of said first and second cover portions has formed therein corresponding openings exposing said line cord, said circuit breaker, said indicator light and said on/off switch.

9. A power strip comprising:
at least a pair of base units, each said base unit including at least one of an electrical outlet and a signal connector;
a first cover portion receiving at least one of said base units and including an aperture formed therein for exposing said at least one of an electrical outlet and a signal connector; and
a second cover portion receiving at least one of said base units and including an aperture formed therein for exposing said at least one of an electrical outlet and a signal connector, said second cover portion being attached to said first cover portion.

10. The power strip according to claim 9 wherein said base units are releasably electrically connected together.

11. The power strip according to claim 9 wherein at least one of said base units includes a surge suppressor module.

12. The power strip according to claim 9 wherein said first and second cover portions are releasably attached.

13. The power strip according to claim 9 wherein at least one of said base units includes a line cord, a circuit breaker, an indicator light and an on/off switch and at least one of said first and second cover portions has formed therein corresponding openings exposing said line cord, said circuit breaker, said indicator light and said on/off switch.

14. The power strip according to claim 9 wherein said base units each have a housing and said first and second cover portions cooperate to form a shape that is different from a shape of said housings.

15. A power strip comprising:
at least one base unit having at least two modules electrically and mechanically connected together, each said module having at least one of an electrical outlet and a signal connector; and
a cover having a first cover portion attached to a second cover portion, said cover receiving said at least one base unit and including an aperture formed therein exposing an associated one of said at least one of an electrical outlet and a signal connector.

16. The power strip according to claim 15 wherein said at least one base unit includes at least one rail subassembly having a plurality of rails extending between a pair of end walls, said at least two modules having contacts electrically connected to said rails.

17. The power strip according to claim 16 including a bottom side wall extending between said end walls.

18. The power strip according to claim 15 wherein said at least two modules include a quick connect means having a male portion on one of said modules and a cooperating female portion on another of said modules.
